(19) United States
(12) Patent Application Publication
(10) Pub. No.: US 2025/0180390 A1
(43) Pub. Date: Jun. 5, 2025

(54) FILLING LEVEL MEASUREMENT ARRANGEMENT

(71) Applicant: SKF Lubrication Systems Germany GmbH, Walldorf (DE)

(72) Inventors: Joerg SCHWARTZ, Potsdam (DE); Peter HOPPE, Nordhorn (DE)

(21) Appl. No.: 18/842,624

(22) PCT Filed: Feb. 22, 2023
(86) PCT No.: PCT/EP2023/054408

§ 371 Date: Aug. 29, 2024

(30) Foreign Application Priority Data
Mar. 2, 2022 (DE) 10 2022 202 131.2

(51) Int. Cl. G01F 23/28

(52) U.S. Cl. CPC G01F 23/28

(57) ABSTRACT

A filling level measurement arrangement (1) for measuring the filling level in a reservoir. The arrangement (1) is arrangeable above a surface (2) of a substance present in the reservoir and has a sensor housing (4) with a base plate (6), which defines an interior space (10). A sensor arrangement with an evaluation electronic system (12) and a sensor element (8) is in the interior space (10). The sensor element (8) is in the base plate (6) and sends a measurement signal towards the surface (2) and receives a reflection signal reflected by the surface (2) in response to the measurement signal. The sensor element (8) is set back in the base plate (6) with respect to the underside (14) of the base plate (6), which is facing the surface (2) of the substance, in the direction of the interior space (10) of the sensor housing (4).

### CROSS-REFERENCE TO RELATED APPLICATION

This application claims priority to and is a 371 National Stage of PCT Application No. PCT/EP2023/054408, filed Feb. 22, 2023, which claims priority to German Application No. 102022202131.2, filed Mar. 2, 2022, the entireties of which are hereby incorporated by reference.

### FIELD

The present disclosure relates to a filling level measurement arrangement for measuring the filling level in a reservoir according to the preamble of claim 1.

### BACKGROUND

Reservoirs can be used to store a fluid or another substance and are usually connected to systems in order to transfer the content of the reservoir to other devices or equipment. The reservoir may, for example, be a lubricant reservoir in which oil or grease is stored, with the lubricant being dispensed to lubrication systems for bearings or similar. It is often necessary to monitor the fill height of the reservoir. The filling level of the reservoir can be monitored by various monitoring devices, such as optical or acoustic sensors, which measure a distance between the surface of the content of the reservoir and the sensor element. The sensor elements are arranged here in such a way that they point in the direction of the reservoir in order to be able to perform their respective functions. However, during service activities, maintenance operations or other movements within the reservoir, e.g. due to stirring of the content, the content of the reservoir, such as grease or oil, can pass into the region of such a sensor element. There is therefore a risk that the sensor element will become heavily contaminated and that the sensor function will no longer be available.

It is therefore the object of the present disclosure to provide a filling level measurement arrangement having a sensor element, in which the sensor element is protected from contamination.

### SUMMARY

This object is achieved by a filling level measurement arrangement for measuring the filling level in a reservoir according to claim 1.

The filling level measurement arrangement for measuring the filling level in a reservoir is arrangeable above a surface of a substance present in the reservoir. The reservoir can be, for example, a lubricant unit with a lubricant, such as grease or oil, or can be any other type of reservoir, such as a fuel tank. In any case, the filling level measurement arrangement is arranged above a surface of the reservoir. The filling level measurement arrangement has a sensor housing with a base plate, wherein the sensor housing with the base plate defines an interior space, wherein a sensor arrangement with an evaluation electronic system and a sensor element is arranged in the interior space of the sensor housing. The sensor element is arranged in the base plate and is designed to send a measurement signal in the direction of the surface and to receive a reflection signal reflected by the surface in response to the measurement signal. The evaluation electronic system can then use the time between the transmission of the measurement signal and the reception of the reflection signal for a time-of-flight measurement to determine a fill height of the substance present in the reservoir.

In order to protect the sensor element in the base plate from contamination in comparison with previous systems, the sensor element is set back, in accordance with the filling level measurement arrangement proposed here, in the base plate relative to the underside of the base plate, which is facing the surface of the substance, in the direction of the interior space of the sensor housing. This means that the sensor element is not aligned flush with the underside of the base plate, but is recessed with respect to this underside and can therefore be better protected from contamination.

According to one embodiment, the base plate has a cylindrical hole in which the sensor element is arranged. Such a cylindrical countersink for the sensor element in the base plate has the advantage that the sensor element can be protected from direct contact, in particular with grease in the reservoir, while at the same time the sensor element is easily accessible, so that cleaning of the sensor element, if necessary, can be carried out easily and without special tools.

According to another embodiment, the base plate has a conical hole, wherein the sensor element is arranged in the tip of the conical hole and the opening of the cone is facing the surface. Such a configuration is advantageous in particular in the case of oil or other fluids in the reservoir, since, depending on the application, the fluid might spray into the region of the sensor element. By countersinking the sensor element with respect to the underside of the base plate, the sensor element is protected from direct contact with such a fluid, and in addition, splashes which enter the region of the sensor element can run in a defined manner down the funnel wall of the conical hole and drain.

According to a further embodiment, the filling level measurement arrangement is arranged centrally above the reservoir. Such a central arrangement is advantageous, since in this way the emission and reception of signals by the sensor element can be ensured. If the filling level measurement arrangement is positioned too far at the periphery of the reservoir, it may be that signals emitted by the sensor element are reflected not by the surface of the content of the reservoir, but by a wall surface of the reservoir. This would lead to a falsification of the fill height determination.

According to a further embodiment, the base plate is an injection moulding element. Such an injection moulding element, in particular made of plastic, is advantageous, as this allows for simple and cost-effective production of the base plate and the recess formed in the base plate for the sensor element. The base plate can be easily inserted into the sensor housing and replaced if necessary.

According to a further embodiment, the base plate is therefore interchangeable and/or the base plate has an interchangeable insert in which the sensor element is attached. In this way, the filling level measurement arrangement can be used for different reservoirs and substances in the reservoir, since the base plate can be adapted accordingly to the content of the reservoir, in particular with regard to the type and configuration of the recess in which the sensor element is arranged.

Further advantages and advantageous embodiments are specified in the description, the drawings and the claims. In particular the combinations of the features specified in the description and in the drawings are purely exemplary here, and therefore the features can also be present individually or in other combinations.

### BRIEF DESCRIPTION OF THE DRAWINGS

In the following text, the present disclosure will be described in more detail using exemplary embodiments illustrated in the drawings. The exemplary embodiments and the combinations shown in the exemplary embodiments are purely exemplary here and are not intended to define the scope of protection of the present disclosure. This is defined solely by the attached claims.

In the drawings:

FIG. 1 shows a schematic sectional view of a filling level measurement arrangement;

FIG. 2: shows a perspective view of an embodiment of a base plate for the filling level measurement arrangement of FIG. 1;

FIG. 3: shows a perspective view of a further embodiment of a base plate for the filling level measurement arrangement of FIG. 1; and

FIG. 4 shows a perspective sectional view of the base plate of FIG. 3.

In the following text, identical or functionally equivalent elements are identified by the same reference signs.

### DETAILED DESCRIPTION

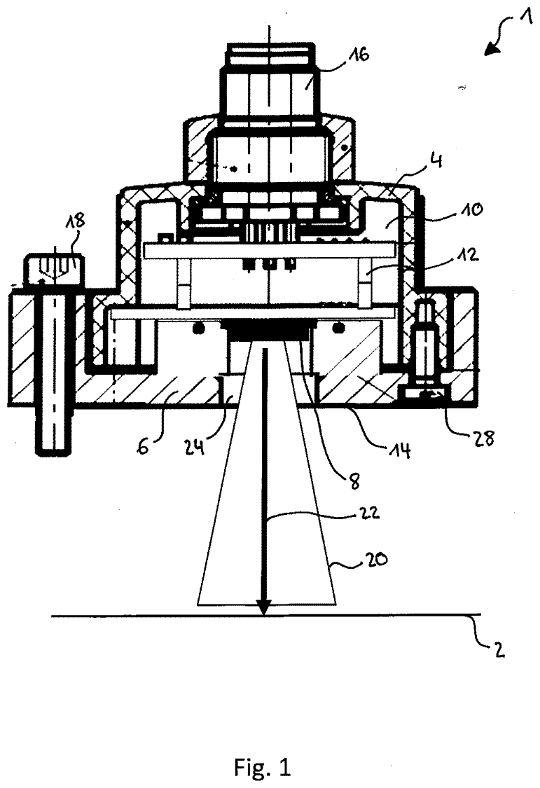

FIG. 1 shows a filling level measurement arrangement 1, which is designed for measuring a fill height of a substance in a reservoir. The filling level measurement arrangement 1 has a sensor housing 4 with a base plate 6, wherein the base plate 6 can be connected to the sensor housing 4 via fastening means 28. The sensor housing 4 defines with its base plate 6 an interior space 10, in which a sensor element 8 and an evaluation electronic system 12 are arranged. Furthermore, the sensor housing 4 comprises a connection 16, via which the filling level measurement system can be connected to external devices, such as computational devices, etc. The filling level measurement system can be connected to the reservoir (not shown) via fastening means 18.

In order to measure the fill height 2, the sensor element 8 is designed to send a signal which is reflected by a surface 2 of the content of the reservoir and is then received again by the sensor element 8. The sensor element 8 may be designed to transmit and/or receive the signal within a measurement lobe 20. Via the transmitted and reflected signal, the evaluation electronic system 12 can then carry out a time-of-flight measurement to determine a distance 22 between the sensor element 8 and the surface 2.

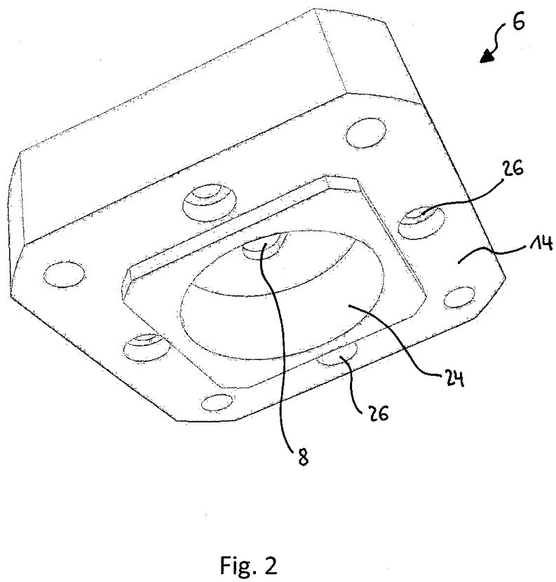

In a reservoir in which, for example, grease is stored, agitator blades may be provided to stir the content of the reservoir. In order to protect the sensor element 8 from contamination by the content of the reservoir, for example due to a movement of the content due to such agitator blades, which spray the content, such as oil, against the sensor element 8, the sensor element 8 is arranged recessed in the base plate 6, as described below with reference to FIGS. 2-4.

FIG. 2 shows a first embodiment of a base plate 6, which can be connected to the sensor housing 4, which is shown in FIG. 1. Although the base plate 6 is shown in the figures as a square base plate 6 with chamfers, the base plate may also be round or rectangular or have another shape.

In order to protect the sensor element 8 from contamination, the base plate 6 shown here has a cylindrical hole 24. The sensor element 8 is arranged at the bottom of this cylindrical hole 24 and is thus set back with respect to the underside 14 of the base plate. In this way, the sensor element 8 is further away from the surface 2 of the content of the reservoir and, in addition, the opening formed by the cylindrical hole 24 is small, as a result of which the probability that the content of the reservoir reaches the sensor element 8 is lower.

The base plate 6 further has fastening openings 26 into which fastening means 28 can be inserted (see FIG. 1) to connect the base plate 6 to the sensor housing 4. The base plate 6 can be replaced to allow the filling level measurement arrangement 1 to be adapted to different fluids or solids in the reservoir, i.e. to adapt the base plate and in particular the opening 24, in which the sensor element 8 is arranged, to the conditions of the reservoir.

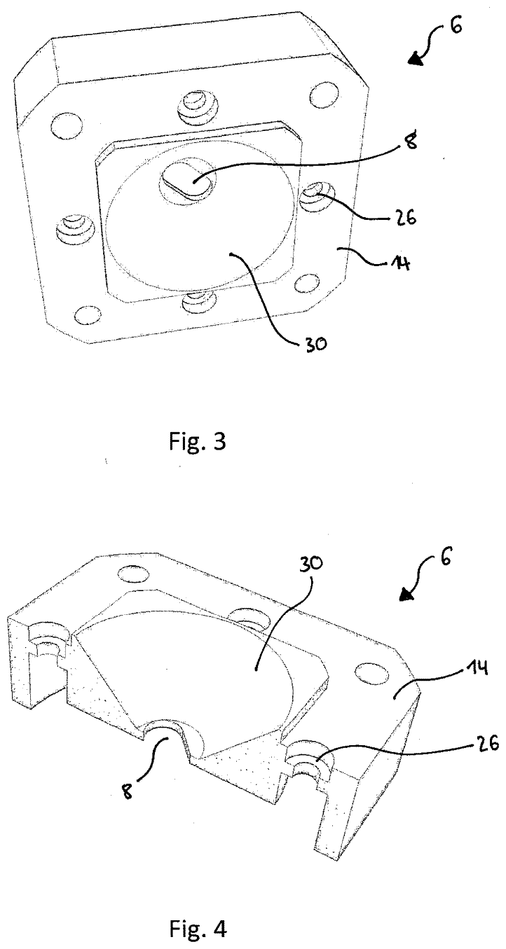

A further configuration of the base plate 6 is shown in FIGS. 3 and 4. In this case, the base plate 6 has a conical hole 30 instead of a cylindrical hole 24 as shown in FIG. 2. Such a conical hole 30 is in particular suitable for fluids in the reservoir, since, due to the conical configuration, a liquid that reaches the sensor element 8 is diverted due to the funnel design of the conical hole 30 away from the sensor element 8 and can drain. The sensor element 8 is arranged in the tip of the cone and thus likewise set back from the underside 14 of the base plate 6.

Using the filling level measurement arrangement proposed here, it is thus possible to arrange a sensor element above a reservoir, wherein the sensor element is protected from contaminations caused by the content of the reservoir.

### LIST OF REFERENCE SIGNS

1 Filling level measurement system
2 Surface
4 Sensor housing
6 Base plate
8 Sensor element
10 Inner element
12 Evaluation electronic system
14 Underside
16 Connection
18 Fastening means
20 Measurement lobe
22 Distance
24 Cylindrical hole
26 Fastening openings
28 Fastening means
30 Conical hole

1. A filling level measurement arrangement for measuring the fill level in a reservoir, the filling level measurement arrangement is being arrangeable above a surface of a substance present in the reservoir, the filling level measurement arrangement comprising;
a sensor housing with a base plate, which defines an interior space, the underside of the base plate being configured to face the surface of the substance
a sensor arrangement with an evaluation electronic system and a sensor element is arranged in the interior space of the sensor housing, the sensor element is arranged in the base plate and is designed to send a measurement signal in the direction of the surface of the substance and to receive a reflection signal reflected by the surface of the substance in response to the measurement signal, the sensor element being set back in the base plate with respect to the underside of the base plate in the direction of the interior space of the sensor housing.

2. The filling level measurement arrangement according to claim 1, wherein the base plate has a cylindrical hole in which the sensor element is arranged.

3. The filling level measurement arrangement according to claim 1, wherein the base plate has a conical hole, wherein the sensor element is arranged in the tip of the conical hole and the opening of the cone is facing the surface.

4. The filling level measurement arrangement according to claim 1, wherein the filling level measurement arrangement is arranged centrally above the reservoir.

5. The filling level measurement arrangement according to claim 1, wherein the base plate is an injection moulding element.

6. The filling level measurement arrangement according to claim 1, wherein the base plate is interchangeable and/or wherein the base plate has an interchangeable insert in which the sensor element is fastened.

7. The filling level measurement arrangement according to claim 2, wherein the filling level measurement arrangement is arranged centrally above the reservoir.

8. The filling level measurement arrangement according to claim 7, wherein the base plate is an injection moulding element.

9. The filling level measurement arrangement according to claim 8, wherein the base plate is interchangeable and/or wherein the base plate has an interchangeable insert in which the sensor element is fastened.

10. The filling level measurement arrangement according to claim 3, wherein the filling level measurement arrangement is arranged centrally above the reservoir.

11. The filling level measurement arrangement according to claim 10, wherein the base plate is an injection moulding element.

12. The filling level measurement arrangement according to claim 11, wherein the base plate is interchangeable and/or wherein the base plate has an interchangeable insert in which the sensor element is fastened.
